(19) United States
(12) Patent Application Publication
(10) Pub. No.: US 2013/0011328 A1
(43) Pub. Date: Jan. 10, 2013

(54) PREPARATION OF CNTS

(75) Inventors: Ralph Weber, Leichlingen (DE); Volker Michele, Koln (DE); Leslaw Mleczko, Dormagen (DE)

(73) Assignee: Bayer Intellectual Property GmbH, Monheim (DE)

(21) Appl. No.: 13/574,321

(22) PCT Filed: Jan. 20, 2011
(86) PCT No.: PCT/EP2011/050782

§ 371 Date: Sep. 20, 2012

(30) Foreign Application Priority Data
Jan. 22, 2010 (DE) 10 2010 005 560.3

(51) Int. Cl. D01F 9/12; B82Y 40/00

(52) U.S. Cl. 423/447.3; 423/447.1; 977/843; 977/844; 977/742

(57) ABSTRACT

The present invention relates to a process comprising the steps a) synthesis of carbon nanotubes, b) optional inerting and c) cooling of the product. The process permits problem-free handling and packing of the carbon nanotube material that is produced.

The present invention relates to a process comprising the steps a) synthesis of carbon nanotubes (synthesis step), b) optional inerting (one or more inerting steps) and c) cooling of the product (cooling step). The process permits problem-free handling and packing of the carbon nanotube material that is produced.

Carbon nanotubes (CNTs) are interesting materials for a large number of applications. Carbon nanotubes are mainly understood as being cylindrical carbon tubes having a diameter of from 0.5 to 100 nm and a length which is a multiple of the diameter. These tubes consist of one or more layers of ordered carbon atoms and have a core which differs in terms of morphology. Carbon nanotubes are also referred to as “carbon fibrils” or “hollow carbon fibres”, for example.

Carbon nanotubes have been known for a long time in the expert literature. Although Iijima (publication: S. Iijima, Nature 354, 56-58, 1991) is generally referred to as the discoverer of carbon nanotubes, these materials, in particular fibrous graphite materials having a plurality of graphite layers, have been known since the 1970s or early 1980s. Tates and Baker (GB 1469930A1, 1977 and EP 56004 A2, 1982) described for the first time the deposition of very fine fibrous carbon from the catalytic decomposition of hydrocarbons. However, the carbon filaments produced on the basis of short-chained hydrocarbons are not characterised in greater detail in respect of their diameter.

The production of carbon nanotubes having diameters smaller than 100 nm is described for the first time in EP 205 556 B1 or WO A 86/03455. There are used here for the production light (i.e. short- and medium-chained aliphatic or mono- or di-nuclear aromatic) hydrocarbons and an iron-based catalyst on which carbon carrier compounds are decomposed at a temperature above 800-900° C.

The methods known today for the production of carbon nanotubes include arc discharge, laser ablation and catalytic processes. In many of these processes, carbon black, amorphous carbon and fibres having large diameters are formed as by-products. In the catalytic processes, a distinction can be made between deposition on supported catalyst particles and deposition on metal centres formed in situ having diameters in the nanometre range (so-called flow processes). In the case of production via the catalytic deposition of carbon from hydrocarbons which are gaseous under reaction conditions (CCVD hereinbelow; catalytic carbon vapour deposition), acetylene, methane, ethane, ethylene, butane, butene, butadiene, benzene and further carbon-containing starting materials are mentioned as possible carbon donors.

Various processes and catalysts are known from the prior art for the catalytic production of carbon nanotubes. The catalysts generally contain metals, metal oxides or decomposable or reducible metal components. For example, Fe, Mo, Ni, V, Mn, Sn, Co, Cu and others are mentioned in the prior art as metals. Although most of the individual metals have a tendency to form nanotubes, high yields and low contents of amorphous carbons are advantageously achieved according to the prior art with metal catalysts which contain a combination of the above-mentioned metals.

The formation of carbon nanotubes and the properties of the tubes that are formed depend in a complex manner on the metal component used as catalyst or a combination of a plurality of metal components, on the support material used and the interaction between the catalyst and the support, on the starting material gas and partial pressure, on an admixture of hydrogen or further gases, on the reaction temperature and on the residence time or the reactor used.

EP-A 0205556 (Hyperion Catalysis International) describes carbon nanotubes that are produced via an iron-containing catalyst and the reaction of various hydrocarbons at high temperatures above 800-1000° C.

Ni-based systems are mentioned by Shaikhutdinov et al. (Shamil' K. Shaikhutdinov, L. B. Avdeeva, O. V. Goncharova, D. I. Kochubey, B. N. Novgorodov, L. M. Plyasova, “Coprecipitated Ni—Al and Ni—Cu—Al catalysts for methane decomposition and carbon deposition I.”, Applied Catalysis A: General, 126, 1995, pages 125-139) as being active in the decomposition of methane to carbon nanomaterials.

CA 2374848 (Centre National de la Recherche Scientifique, FR) discloses as a possible process for the mass production of carbon nanotubes a process in which a yield of 3 g CNTs/g catalyst is achieved on a cobalt catalyst with acetylene as carbon donor. However, this comparatively very low yield makes the process appear unattractive for an industrial-scale reaction.

Mauron et al. (Ph. Mauron, Ch. Emmenegger, P. Sudan, P. Wenger, S. Rentsch, A. Züttel, “Fluidised-bed CVD synthesis of carbon nanotubes on Fe₂O₃/MgO”, Diamond and Related Materials 12 (2003) 780-785) likewise achieve only very low yields in the production of CNTs from isopentane or acetylene on an iron catalyst.

EP-A 1399384 (Institut National Polytechnique, Toulouse, FR) describes the production of carbon nanotubes in a CCVD process with an upstream reactor for inline catalyst production, wherein the catalyst can have a mean particle size of from 10 μm to 1000 μm and can achieve an increase in the volume of the agglomerates of up to twenty times the amount of catalyst.

In addition to the actual production step, the process steps provided downstream of the actual synthesis in a process for the production of carbon nanotubes on an industrial scale are also of great importance for the economic and reliable production of a high-quality product with product properties which can reliably be reproduced. However, the prior art mostly describes test results which were obtained on the laboratory scale or on a small scale. The descriptions are therefore limited to the process step of product inerting (i.e. separation of combustible gases such as, for example, hydrogen or residues of starting material gas) provided downstream of the production step. The necessity of an efficient cooling step for production on an industrial scale, which ensures rapid product cooling, has hitherto not been recognised, although cooling represents a potential bottleneck in the production process as a whole.

For example, EP-A 1594802 (Université de Liège) describes the production of carbon nanotubes by means of CCVD in a rotary tubular reactor which has a flush valve at the reactor outlet. At the inlet and outlet of the reactor, the pulverulent starting materials and products are flushed with inert gas. Only tests on a laboratory scale are described in the examples of the patent. Because both the exchange of material and the dissipation of heat are greatly dependent on the scale, this process without an efficient cooling step cannot be carried out on an industrial scale because packing into suitable commercial containers such as, for example, drums or Big Bags cannot take place directly because the temperatures are too high, and the production capacity of the installation would be reduced. In addition, there would be an acute risk of fire if the still hot product came into contact with the ambient air.

EP-A 2107140 (Grupo Antolín Ingeniería) describes an apparatus which is used in a process step provided downstream of the production of carbon nanotubes. In this apparatus, the carbon nanotubes are first to be cleaned of adhering associated materials by flushing with inert gas, but the still high temperatures of the product are then to be used for one or more reactions and/or surface modifications provided downstream. Here too, the product is still hot when it leaves the reactor and must subsequently be cooled in a complex operation. The non-inerted, pulverulent, highly porous product obtained in the production of CNTs by means of CCVD is still highly reactive to air in the hot state after the reaction, in the case of both batchwise and continuous production, even after removal of the adhering residues of combustible gases (e.g. carbon donor gas such as ethylene or product gas hydrogen), and must therefore generally be carefully inerted and cooled before it can be packed and despatched. Such production steps provided downstream of the synthesis on an industrial scale are essential to the production process because the production capacity can otherwise be impaired (e.g. lengthening of the batch cycles). However, owing to the comparatively low bulk density and relatively poor thermal conductivity of the carbon nanotubes, rapid, efficient and gentle cooling is not a triviality and cannot be effected by the arbitrary use of standardised cooling steps: For example, heat dissipation by passing a cold gas through the bulk product is not very efficient because, owing to the low bulk density of the product, only low gas velocities can be used in order to avoid abrasion as well as the discharge of product with the gas stream; accordingly, the heat flow which can be dissipated is greatly limited, and cooling is accordingly very inefficient, nor can the formation of dead zones with poor through-flow and high temperatures be ruled out. In addition, reducing the flushing gas requirement is also relevant in terms of costs, because the waste gas must be subjected to an expensive cleaning operation before it is released into the surroundings.

In addition to cooling, inerting of the product must also take place in order to ensure, for reasons of health and safety and explosion prevention, that the end product is as free as possible of adhering residues of starting material gas and residues of starting material gas in the intergranular spaces. This process step too, which is typically carried out in the prior art by passing through a suitable inerting gas such as, for example, nitrogen or argon, cannot simply be scaled up from the laboratory scale to an industrial scale without efficiency losses, for the same reasons as mentioned for cooling.

Overall, the production processes described in the prior art lack process steps—provided downstream of the actual carbon nanotube synthesis—which, for an economical and reliable process on an industrial scale, take into consideration the aspects of as short a residence time as possible on cooling, reliable cooling, where appropriate also of products which are poorly flowable and not resistant to abrasion, as well as adaptability to the production process in respect of possible operation in batchwise or continuous operating mode.

In order to make the production process as flexible as possible it would additionally be desirable to provide a process comprising process steps for product cooling and inerting which is suitable for both fully continuous reactor operation and virtually continuous reactor operation (very short batch cycles in which only a small proportion of the product present in the reactor is removed in each case) or for purely batchwise reactor operation.

It was, therefore, an object of the invention described here to develop an overall process for the production of carbon nanotubes comprising a) a synthesis step, b) optionally a step for inerting and c) a step for cooling the product, by which process a product is provided which is largely free of all disturbing (gas) adhesions and is cooled to such an extent that it can be packed without problems, wherein the after-treatment steps are to be inserted independently into the time sequences of the production step without causing a bottleneck.

The object has been achieved by a process which has the features of claim 1 of the present invention. The process comprises the steps
a) synthesis of the carbon nanotubes,
b) optional inerting of the carbon nanotubes,
c) cooling of the product by means of a cooling system in which the product is simultaneously conveyed and moved,
   wherein the individual process steps are characterised as follows:

### a) Synthesis of the Carbon Nanotubes

The synthesis of the carbon nanotubes is preferably carried out by the CCVD process, that is to say the catalytic deposition of carbon from hydrocarbons that are gaseous under reaction conditions. As products for use there may be mentioned carbon donors such as acetylene, methane, ethane, ethylene, butane, butene, butadiene, benzene, and further starting materials containing carbon.

The actual CCVD synthesis process is known from the general prior art discussed above. Synthesis conditions as described in WO 2006050903 A2 and WO 2007118668 A2 are preferably used. There are generally used as catalysts transition metals on support materials, the composition of which is discussed, for example, in WO 2006050903 A2 and the preparation of which is discussed, for example, in WO 2007093337 A2. Preference is given to the use of coprecipitated Co—Mn catalysts with Al₂O₃ and MgO as support materials prepared in a continuous process according to WO 2007093337 A2 (page 8).

The reactors used for the synthesis step are those as described in WO 2006050903 A2, that is to say, for example, fixed bed reactors, tubular reactors, rotary tubular reactors, migrating bed reactors, reactors with a bubble-forming, turbulent or irradiated fluidised bed as well as internally or externally circulating fluidised beds. A fluidised bed reactor according to WO 2007118668 A2 is preferably used.

### c) Cooling of the Product

Cooling of the product is carried out by an installation part which is arranged downstream of the reaction apparatus or integrated therein and in which the material can be both conveyed and moved in the cooling step in order to ensure good contact with the apparatus wall, or with any cooled built-in components of the container, for rapid and effective cooling. It is important here that movement of the product is carried out in such a manner that abrasion of the material and the associated production of dust is minimised in order thus to minimise losses and ensure or obtain dust-free handling of the product.

Therefore, there are suitable for this cooling step only those apparatuses which ensure good heat transfer of the bulk product at the cooled container wall or at corresponding cooled built-in components of the container, while at the same time providing low-wear active mechanical conveying. “Active” within the scope of this invention refers to a movement that is not brought about by the action of gravity alone. As apparatuses with active conveying there may be mentioned, for example, rotary tubes, cooling screws, fluidised beds or vibrating spiral conveyors.

### b) Optional Inerting Step

An inerting step is optionally also provided downstream of the synthesis step.

This can advantageously be integrated into the cooling step, the intergranular gas being displaced partially or completely by means of intensive and uniform contact with a flushing gas that is passed through and the disruptive adsorbed associated materials being partially or completely desorbed.

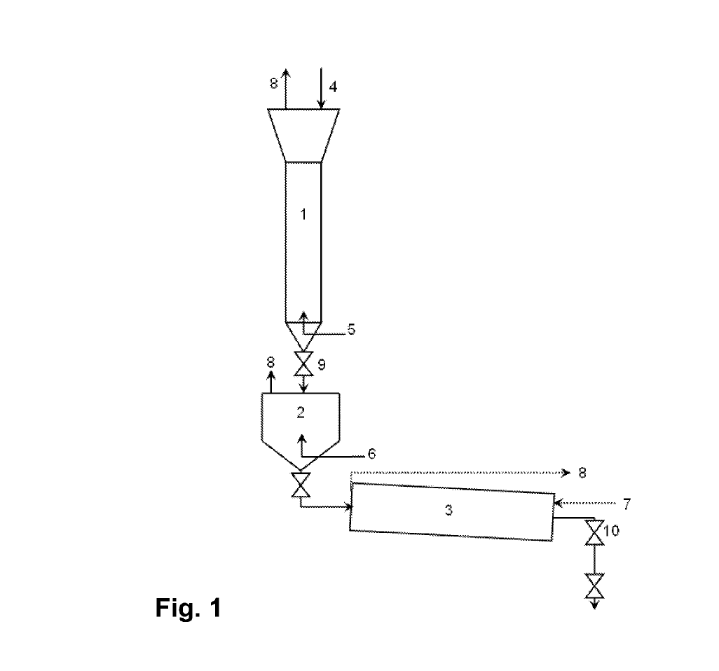

In a further embodiment, the steps of inerting and cooling can also be carried out in two separate apparatuses. This can be expedient in particular when either the synthesis step or the cooling step does not proceed continuously or virtually continuously but takes place batchwise. The required buffer container between the synthesis step and the cooling step can then efficiently also perform the function of inerting, product movement not being necessary in that container (representation see FIG. 1).

In a further embodiment, the steps of inerting and cooling can also be integrated into the reaction apparatus. This is advantageous, for example, when the reaction apparatus is a continuously operated rotary tubular reactor because, in such apparatuses, the product is generally already precooled before it leaves the reactor as a result of the wall cooling necessary to protect the reactor mounting.

Step b) can take place before or after step c). Preferably, step b) takes place—at least partially—before step c).

In a particularly preferred embodiment, the inerting is carried out while the product is still hot. In a particularly preferred embodiment of the invention, therefore, the inerting takes place in a step provided downstream of the synthesis step by flushing of the reaction product while it is still at high temperatures, in order to ensure that even less readily volatile adhesions can be discharged. In this case, the inerting step can also take place in a heatable apparatus. Only then is rapid and effective cooling to the temperature required for safe packing carried out.

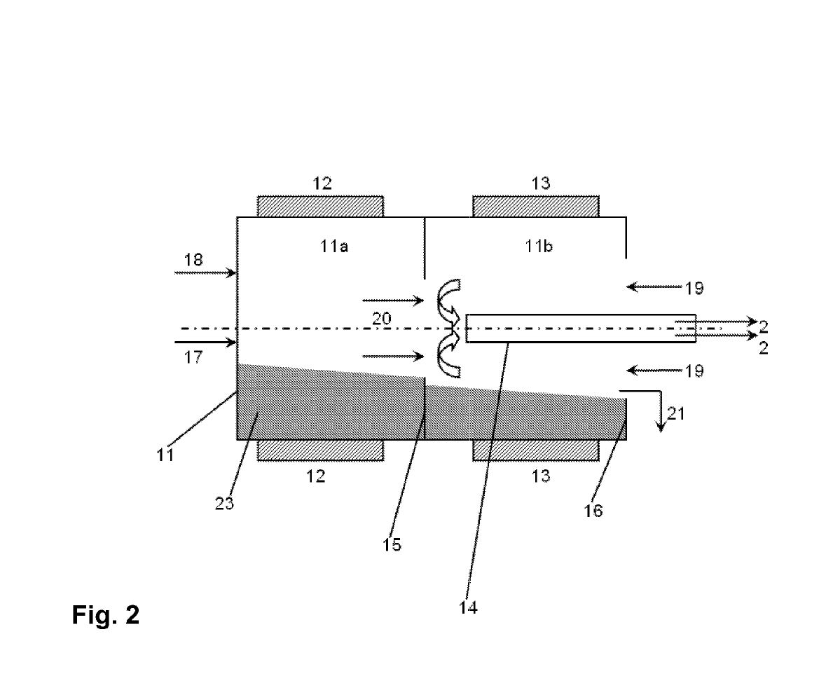

In a particularly preferred embodiment, steps a), b) and c) all take place in one apparatus, for example the synthesis step takes place in a rotary tubular reactor and the inerting step and the cooling step are integrated into the rotary tube in terms of apparatus. For continuous production, the steps are spatially separate from one another in different zones in the rotary tube, product inerting can be ensured by the purposive addition of inerting gas in the inerting region. FIG. 2 shows a schematic diagram of a correspondingly compartmentalised rotary tube apparatus with a synthesis zone as well as an inerting and cooling zone. The desorption of constituents of the starting material gas or waste gas adhering to the pulverulent CNT product is effected by the inerting gas, which is fed counter-currently to the CNT product and is preheated thereby; at the same time, the CNT product is correspondingly cooled by the inerting gas.

The process according to the invention can be used very flexibly. It can be used both in a batch (batchwise) procedure and in a continuous procedure. This is true both for the process as a whole and for the individual steps: For example, the synthesis can take place by the batch process, inerting and cooling are carried out continuously. Instead of a fully continuous operating mode it is also possible to choose a virtually continuous operating mode, in which only a small proportion of the product present in the reactor is removed in very short batch cycles. The process according to the invention can be converted to an industrial scale without difficulty, as is shown in the implementation examples.

Preferred and advantageous embodiments of the process according to the invention and of the device according to the invention are indicated in the sub-claims and described below. Further embodiments of the invention will become apparent to the person skilled in the art in an obvious manner from the present description. The process according to the invention for the production of carbon nanotubes by high-temperature synthesis is characterised in that it comprises the steps a) synthesis of carbon nanotubes (synthesis step), b) optional inerting (one or more inerting steps) and c) cooling of the product (cooling step), wherein the cooling step is carried out with active movement of the product.

In a preferred embodiment, synthesis and/or inerting and/or cooling are carried out batchwise or continuously.

The synthesis step by means of catalytic chemical vapour deposition preferably takes place in a rotary tubular reactor, a fluidised bed or a fixed bed reactor or by means of laser ablation or by means of the arc discharge process.

In an embodiment, the inerting step and the cooling step can be carried out in a plurality of mutually connected apparatuses; in another embodiment, the inerting step and the cooling step take place in one apparatus.

Cooling/the cooling step preferably takes place in a rotary tube, a cooling screw, a fluidised bed or a vibrating spiral conveyor.

In an embodiment, the inerting step, or one of a plurality of inerting steps, takes place in a buffer container with a bed that is not actively mechanically moved. It can take place in a heatable apparatus.

A preferred embodiment of the process is catalytic chemical vapour deposition in a rotary tubular reactor, and at least one of the process steps inerting and cooling is integrated into the rotary tubular reactor in terms of apparatus.

In another preferred embodiment, the synthesis step takes place by means of catalytic chemical vapour deposition in a fluidised bed reactor, and the inerting and cooling steps take place in one or more apparatuses arranged downstream.

In an embodiment, the synthesis step is operated batchwise and the inerting step, or one of a plurality of inerting steps, is integrated into the reactor in the form of an inert gas flushing provided downstream of the synthesis step.

In another embodiment, the synthesis step is operated continuously or virtually continuously and the inerting step, or one of a plurality of inerting steps, takes place in an apparatus arranged downstream of the reactor.

In an embodiment, at least two apparatuses, in which inerting and cooling take place, are arranged downstream of the reactor, at least one of which apparatuses is operated with active mechanical product movement. Preferably, one of the downstream apparatuses is operated continuously.

The invention is explained in detail below with reference to drawings showing exemplary embodiments. In the drawings:

FIG. 1 shows, in diagrammatic form and by way of example, the arrangement of fluidised bed reactor (1, synthesis step, operated batchwise), buffer container (2, inerting) and rotary cooling tube (3, operated continuously) for a possible embodiment of the described process. Further elements of the drawing: 4 addition of catalyst, 5 supply of starting material gas, 6 supply of inerting gas, 7 optional supply of inerting gas, 8 waste gas, 9 removal of CNT product from the reactor, 10 inerted and cooled CNT product for packing.

FIG. 2 shows, in diagrammatic form and by way of example, a continuously operated rotary tubular reactor with integrated inerting and product cooling, in which the inerting gas (e.g. nitrogen) flows counter-currently to the pulverulent product. Elements of the drawing: 11 rotary tube, 11a synthesis zone, 11b inerting and cooling zone, 12 heating, 13 cooling, 14 suction lance, 15 1st baffle plate (rotating), 16 2nd baffle plate (rotating or stationary), 17 supply of catalyst, 18 supply of starting material gas, 19 supply of inerting gas, 20 waste gas from the reaction, 21 overflow of CNT product for packing, 22 waste gas from the reaction and inerting gas, 23 bulk CNT.

The present invention is explained further by the following examples.

### EXAMPLES

### Example 1 (According to the Invention)

### Test of Efficient and Gentle Cooling in the Rotary Tube

The rotary tubular apparatus used has an inside diameter of 300 mm, a drum wall thickness of 5 mm, an air-cooled length of 560 mm and a length cooled by sprinkling with water of 1860 mm; the gradient of the rotary tube is 1%, no built-in components such as lifting bars or the like are present. Upstream of the cooling region is an oven zone in which the product is heated. The rotary tube is charged continuously with commercially available carbon nanotube agglomerates (Baytubes® C 150 P, Bayer MaterialScience AG, bulk density 150-160 kg/m³, heat capacity 710 J(kg K)) via an oscillating conveyor and a conveyor screw. In the oven zone, indirect heating of the product takes place while flushing with nitrogen is carried out simultaneously. At the end of the heating zone there is a radiation shield in order to reduce the radiation of heat from the inside of the drum into the cooling zone. After the heating zone, the product passes through the air-cooled section before entering the actual indirectly cooled water-cooled zone. At the end of the cooling drum, the finished product falls into the delivery chute of the discharge head. The delivery chute is separated from the ambient air by a double-flap sluice. The double-flap sluice is followed by a collecting container flushed with nitrogen. The temperature of the oven zone in the tests was 1000° C., the speed of the rotary tube was 4.5 min⁻¹, the flow rate of water for indirect cooling was 300 l/h. Values of 5.6, 7.5 and 10.0 kg/h were set for the solids throughput. For these three throughputs, the product temperatures determined at the end of the heating zone (entry into the cooling region) were 582, 561 and 613° C., respectively, and the product temperatures determined in the discharge container were 36, 39 and 51° C., respectively. A change in the bulk density or the particle size distribution of the product as an indication of mechanical stress caused by the treatment in the rotary tube could not be detected.

### Example 2 (not According to the Invention)

In a continuously operated rotary tube apparatus (inside diameter 254 mm, length heated electrically from the outside 3048 mm, speed 5 min⁻¹, gradient 1°), carbon nanotubes are produced at 650° C. according to WO 2006050903 A2 using ethylene as starting material gas and pulverulent Co—Mn—Al₂O₃—MgO catalyst. The ethylene flow rate is 120 ln/min, the mass flow of catalyst is 120 g/h. Starting material gas and catalyst are added at the same end of the reactor and flow co-currently through the apparatus, there being formed a pulverulent product of CNT agglomerates with a yield of about 40 g of CNTs per g of catalyst and a bulk density of about 140 kg/m³. Downstream of the heated region there is provided a second region of about 1800 mm in length, in which the rotary tube is cooled from the outside by free convection. At the end of the second region there is a non-rotating baffle plate, via which the pulverulent CNT product falls into an alternating pressure sluice; the waste gas containing ethylene and hydrogen is fed to waste gas combustion. On entering the sluice, the CNT product has a temperature of less than 50° C. In the sluice, the CNT product is flushed cyclically with nitrogen and then evacuated to an absolute pressure of 100 mbar; after 3 such alternating pressure cycles, the product falls via a weighing system into a storage drum which is standing ready. When the storage drum is opened, a marked ethylene odour is perceived, that is to say the desorption of the residue of starting material gas adhering to the product has been incomplete at the low sluice temperature.

### Example 3 (not According to the Invention)

### Laboratory Scale

CNT synthesis and inerting in a steel fluidised bed reactor having a diameter of 100 mm, cooling in a discharge container without movement.

In a steel fluidised bed (inside diameter 100 mm, bed height not more than 1000 mm, heated electrically to a bed temperature of 650° C.), carbon nanotubes are produced in a batchwise process. At the beginning of a charge, 24 g of a pulverulent Co—Mn—Al₂O₃—MgO catalyst according to WO 2006050903 A2 are introduced into the reactor via a sluice, and then 36 ln/min ethylene and 4 ln/min nitrogen are introduced into the reactor for 34 minutes. The ethylene reacts on the catalyst to give carbon nanotubes and hydrogen, the catalyst particles are broken open, CNT agglomerates are formed and the bed height in the reactor increases. At the end of the charge time, the supply of ethylene is stopped and the product bed is fluidised with 40 ln/min nitrogen until no more ethylene and no more hydrogen are detected in the waste gas at the reactor outlet; heating remains activated during this time. Then 826 g of pulverulent CNT agglomerates (bulk density 148 kg/m³) are discharged through a discharge valve from the reactor into a cylindrical discharge container flooded with argon (heavier than air). When the removal of product is complete, the discharge container is set to one side and allowed to cool in the air. 100 ln/h of argon are thereby passed through the unmoved bulk product via a lance, in order to ensure that the hot product is rendered inert and to avoid combustion in the air. During this time, the next charge is produced in the reactor; before the end thereof (after a further 34 minutes), the product in the discharge container is sufficiently cooled (below 250° C.) that it can be transferred without danger to a storage drum made of sheet steel; the discharge container is thus available for the next charge. The pulverulent CNT product obtained is absolutely odour-free.

### Example 4 (not According to the Invention, Sample Calculation)

In a cube-shaped silo (edge length l=1 m) there are m=150 kg of pulverulent CNT product. The heat capacity cₚ of the CNT product is estimated at 0.7 kJ/kg and the thermal conductivity T₀ of the bulk product is estimated at 0.4 W/(m K). The starting temperature T₀ of the bulk material is 650° C., as in Examples 2 and 3, and the ambient temperature T_{U}=20° C. The product is to be cooled to T_{E}=50° C. purely by thermal conduction. The time t required for the cooling is then calculated approximately according to the following equation:

$$t = \frac{l \cdot m \cdot {c}_{p} \cdot ( {T}_{0} - {T}_{E} )}{2 \cdot λ \cdot 6 \cdot {l}^{2} \cdot \frac{( {T}_{0} - {T}_{U} ) - ( {T}_{E} - {T}_{U} )}{ln ( \frac{( {T}_{0} - {T}_{U} )}{( {T}_{E} - {T}_{U} )} )}}$$

With the mentioned data, an approximate cooling time t of 18.5 hours is obtained. This value is unacceptably high for industrial application because the capacity of an upstream synthesis apparatus would be drastically reduced, or an uneconomically large number of such cooling containers would be required. Even longer cooling times are obtained if the dimensions of the silo are increased.

1-15. (canceled)

16. A process for production of a product of carbon nanotubes by high-temperature synthesis, comprising the steps of:
a) synthesis of carbon nanotubes in a synthesis step,
b) optional inerting of the carbon nanotubes in one or more inerting steps; and
c) cooling of the product in a cooling step, wherein the cooling step takes place with active movement of the product.

17. The process according to claim 16, wherein one or more steps selected from the group containing the synthesis step, the inerting steps and the cooling step take place batchwise or continuously.

18. The process according to claim 16, wherein the synthesis step takes place by means of catalytic chemical vapour deposition in a rotary tubular reactor, a fluidised bed or a fixed bed reactor or by means of laser ablation or by means of the arc discharge process.

19. The process according to claim 16, wherein the inerting step, or at least one of a plurality of inerting steps, and the cooling step are carried out in a plurality of mutually connected apparatuses.

20. The process according to claim 16, wherein the inerting step, or at least one of a plurality of inerting steps, takes place in a buffer container with a bed that is not actively mechanically moved.

21. The process according to claim 16, wherein cooling is carried out in one of a rotary tube, a cooling screw, a fluidised bed or a vibrating spiral conveyor.

22. The process according to claim 16, wherein the inerting step, or at least one of a plurality of inerting steps, and the cooling step take place in one apparatus.

23. The process according to claim 16, wherein the inerting step, or at least one of a plurality of inerting steps, takes place in one apparatus.

24. The process according to claim 16, wherein the inerting step, or at least one of a plurality of inerting steps, takes place in a heatable apparatus.

25. The process according to claim 16, wherein the synthesis step takes place by means of catalytic chemical vapour deposition in a rotary tubular reactor, and at least one of the process steps inerting and cooling is integrated into the rotary tubular reactor in terms of apparatus.

26. The process according to claim 16, wherein the synthesis step takes place by means of catalytic chemical vapour deposition in a fluidised bed reactor, and inerting and cooling take place in one or more apparatuses arranged downstream.

27. The process according to claim 16, wherein the reactor is operated batchwise and the inerting step, or at least one of a plurality of inerting steps, is integrated into the reactor in the form of inert gas flushing provided downstream of the synthesis step.

28. The process according to claim 16, wherein the reactor is operated continuously or virtually continuously and the inerting step, or at least one of a plurality of inerting steps, takes place in one or more apparatuses arranged downstream of the reactor.

29. The process according to claim 26, wherein at least two apparatuses, in which inerting and cooling take place, are provided downstream of the reactor, at least one of which apparatuses is operated with active mechanical product movement.

30. The process according to claim 28, wherein at least one of the apparatuses provided downstream is operated continuously.
